(19) United States
(12) Patent Application Publication
(10) Pub. No.: US 2026/0122445 A1
(43) Pub. Date: Apr. 30, 2026

(54) AUDIO SYSTEM AND METHOD

(71) Applicant: HARMAN BECKER AUTOMOTIVE SYSTEMS GmbH, Karlsbad-Ittersbach (DE)

(72) Inventors: Christopher OATES, Bamberg (DE); Sreejith GOPAKUMAR, Pfaffenhofen an der Ilm (DE); Friedrich VON TÜRCKHEIM, Hamburg (DE)

(21) Appl. No.: 19/371,521

(22) Filed: Oct. 28, 2025

(30) Foreign Application Priority Data
Oct. 30, 2024 (EP) 24209738.4

(51) Int. Cl. H04S 7/00

(52) U.S. Cl. CPC H04S 7/305; H04S 2400/11; H04S 2400/15

(57) ABSTRACT

A audio system comprises an analysis unit, configured to receive and analyze a first number of audio signals, an ambient sound unit, configured to determine one or more ambient sounds related to the semantic information of the first number of audio signals obtained by the analysis unit, a sound placement unit, configured to determine a placement of the one or more ambient sounds determined by the ambient sound unit in one or more audio signals of the first number of audio signals, or in one or more processed audio signals of a second number of processed audio signals, and a combiner to combine the one or more ambient sounds with one or more audio signals of the first number of audio signals or with one or more processed audio signals of the second number of processed audio signals, to generate a second number of audio output signals.

### CROSS-REFERENCE TO RELATED APPLICATIONS

This application claims priority benefit to European Patent Application Number 24209738.4, entitled “AUDIO SYSTEM AND METHOD” and filed October 30, 2024, the contents of which are incorporated herein by reference in its entirety.

### BACKGROUND

### Field of the Various Embodiments

The disclosure relates to an audio system and related method, in particular an audio system and method for adding 3D information to an audio signal.

### Description of the Related Art

There is an increasing demand for Augmented Reality, AR, features in audio content. By adding AR features such as, e.g., ambient sounds, to an audio signal, thereby simulating a certain listening environment, the listening experience of a user to whom the audio signal is presented can be significantly increased. Simple stereo content can be enhanced to realistic 3D audio content. Acoustically simulating a specific kind of listening space by suitably adding and reproducing matching ambient sounds, however, can be challenging.

There is a need for an audio system and related method that add AR features to an audio signal to simulate a listening environment by extending an audio signal with 3D information, resulting in a highly satisfying listening experience for a listener, while requiring comparably little computational load.

### SUMMARY

An audio system includes an analysis unit, configured to receive and analyze a first number of audio signals, wherein analyzing the first number of audio signals includes obtaining semantic information of the first number of audio signals, an ambient sound unit, configured to determine one or more ambient sounds related to the semantic information of the first number of audio signals obtained by the analysis unit, a sound placement unit, configured to determine a placement of the one or more ambient sounds determined by the ambient sound unit in one or more audio signals of the first number of audio signals, or in one or more processed audio signals of a second number of processed audio signals, and a combiner, configured to, based on the placement determined by the sound placement unit, combine the one or more ambient sounds determined by the ambient sound unit with one or more audio signals of the first number of audio signals or with one or more processed audio signals of the second number of processed audio signals, in order to generate a second number of audio output signals.

A method incudes receiving and analyzing, at an analysis unit of an audio system, a first number of audio signals, wherein analyzing the first number of audio signals includes obtaining semantic information of the first number of audio signals, determining, at an ambient sound unit of the audio system, one or more ambient sounds related to the semantic information of the first number of audio signals obtained by the analysis unit, determining, at a sound placement unit of the audio system, a placement of the one or more ambient sounds determined by the ambient sound unit in one or more audio signals of the first number of audio signals, or in one or more processed audio signals of a second number of processed audio signals, and, at a combiner of the audio system, based on the placement determined by the sound placement unit, combining the one or more ambient sounds determined by the ambient sound unit with one or more audio signals of the first number of audio signals or with one or more processed audio signals of the second number of processed audio signals, in order to generate a second number of audio output signals.

Other systems, methods, features and advantages will be or will become apparent to one with skill in the art upon examination of the following detailed description and figures. It is intended that all such additional systems, methods, features and advantages be included within this description, be within the scope of the disclosure and be protected by the following claims.

### BRIEF DESCRIPTION OF THE DRAWINGS

The arrangements may be better understood with reference to the following description and drawings. The components in the figures are not necessarily to scale, emphasis instead being placed upon illustrating the principles of the disclosure. Moreover, in the figures, like referenced numerals designate corresponding parts throughout the different views.

FIG. 1 schematically illustrates an audio system according to embodiments of the disclosure.

FIG. 2 schematically illustrates an audio system according to further embodiments of the disclosure.

FIG. 3, in a flow chart, schematically illustrates a method according to embodiments of the disclosure.

### DETAILED DESCRIPTION

As required, detailed embodiments of the present disclosure are disclosed herein; however, it is to be understood that the disclosed embodiments are merely examples of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

It is recognized that directional terms that may be noted herein (e.g., “upper”, “lower”, “inner”, “outer”, “top”, “bottom”, etc.) simply refer to the orientation of various components of an arrangement as illustrated in the accompanying figures. Such terms are provided for context and understanding of the disclosed embodiments.

Many users are not fully satisfied with traditional stereo music experience, and wish for a more immersive, engaging, and realistic auditory experience, especially when listening to musical pieces. Existing 3D technologies are able to transform simple stereo content (e.g., stereo music) into 3D content. Current solutions are able to, e.g., simulate acoustics of specific venues such as small or large concert halls, jazz bars, etc. Such technologies are able to provide a sense of depth and directionality, thereby providing a listening experience that is generally satisfying for many users. The audio system and method according to embodiments of the disclosure and as described herein, however, are able to enhance a user’s listening experience even further. In particular, the audio system and method according to embodiments of the disclosure are able to provide a truly immersive, augmented reality (AR) musical experience.

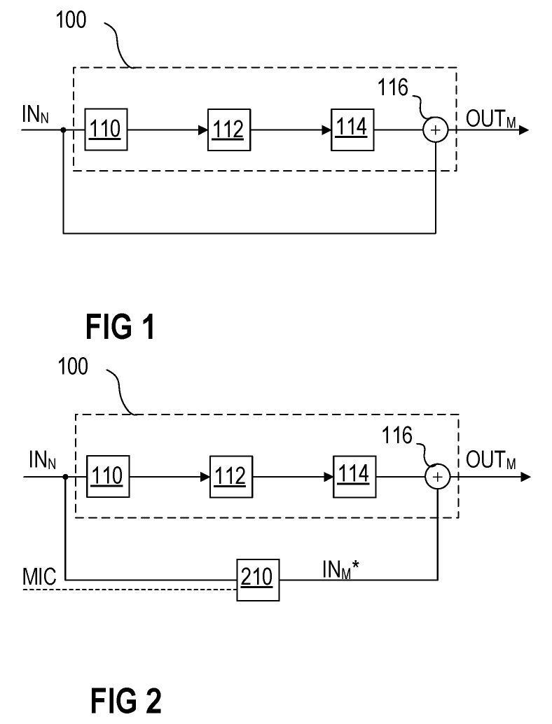

Referring to FIG. 1, an audio system 100 according to embodiments of the disclosure is schematically illustrated. The audio system 100 comprises an analysis unit 110, and ambient sound unit 112, and a sound placement unit 114. The analysis unit 110 is configured to receive and analyze a first number of audio signals INN, wherein analyzing the first number of audio signals INN comprises obtaining semantic information of the first number of audio signals INN. The ambient sound unit 112 is configured to determine one or more ambient sounds related to the semantic information of the first number of audio signals INN obtained by the analysis unit 110. The sound placement unit 114 is configured to determine a placement of the one or more ambient sounds determined by the ambient sound unit 112 in one or more audio signals INN of the first number of audio signals INN, or in one or more processed audio signals INM* of a second number of processed audio signals INM*. The audio system 100 further comprises a combiner 116 that is configured to, based on the placement determined by the sound placement unit 114, combine the one or more ambient sounds determined by the ambient sound unit 112 with one or more audio signals INN of the first number of audio signals INN or with one or more processed audio signals INM* of the second number of processed audio signals INM*, in order to generate a second number of audio output signals OUTM. The combiner 116 may include or may be an adder or a mixer, for example.

In the example illustrated in FIG. 1, the combiner 116 is configured to, based on the placement determined by the sound placement unit 114, combine the one or more ambient sounds determined by the ambient sound unit 112 with one or more audio signals INN of the first number of audio signals INN. That is, the audio signals INN included in the first number of audio signals INN are not processed in any way before combining them with one or more ambient sounds. The number of audio output signals OUTM included in the second number of audio output signals OUTM in this example equals the number of audio signals INN included in the first number of audio signals INN. The audio system 100 may be configured to output the second number of audio output signals OUTM to an audio reproduction unit, for example (audio reproduction unit not specifically illustrated in FIG. 1).

According to some embodiments, obtaining semantic information of the first number of audio signals INN may comprise determining at least one of a genre of, a rhythm of, a melody of, a structure of, lyrics of, a tempo of, a level of noise in, an energy in, and a cultural background of the first number of audio signals INN, to mention only some among a plurality of examples. According to some embodiments, the first number of audio signals INN may include musical content. That is, the first number of audio signals INN may constitute a musical piece. Certain ambient sounds are generally associated with certain types of musical pieces. For example, if a genre of a musical piece is determined as “Jazz”, ambient sounds typically occurring in a jazz bar may be added. Ambient sounds typically occurring in a jazz bar may include, e.g., soft murmurs, whispered conversation, clinking glasses, shuffling chairs, footsteps, foot tapping, soft sparse claps, etc. If, for example, a genre of a musical piece is determined as “Rock”, ambient sounds typically occurring at a rock concert or festival may be added. Ambient sounds typically occurring at a rock concert or a festival may include, e.g., near and far-field voices, (loud) cheers, chants, whistles, rhythmic claps, screams, etc. If, for example, a genre of a musical piece is determined as “Classical”, ambient sounds typically occurring at a concert hall may be added. Ambient sounds typically occurring at a concert hall may include, e.g., applause, coughing, murmuring, whispering, page turning (e.g., sheet of music), etc.

As mentioned above, instead of or in addition to a genre of the first number of audio signals INN, other semantic information may be obtained in order to determine matching ambient sound that is to be combined with at least some of the first number of audio signals INN. Generally speaking, the one or more ambient sounds may comprise at least one of murmurs, loud conversation, whispered conversation, clinking of glasses, shuffling of chairs, footsteps, foot tapping, clapping, applause, coughing, whispering, page turning sounds, near-field voices, far-field voices, cheering, chanting, whistling, rhythmic clapping, and screams. In some embodiments only one ambient sound (e.g., applause) may be combined with the first number of audio signals INN. According to other embodiments, two or more different ambient sounds (e.g., applause, coughing, whispering) may be combined with the first number of audio signals INN. This may depend on the semantic information obtained, or on ambient sounds that are available to the audio system 100, for example.

According to some embodiments, the ambient sound unit 112 may be further configured to retrieve the one or more ambient sounds related to the semantic information of the first number of audio signals INN obtained by the analysis unit 110 from a database of ambient sounds. The database may store a certain amount of pre-recorded or previously generated ambient sounds. The ambient sound unit 112 may be configured to choose from the ambient sounds stored in the database any ambient sound(s) related to the semantic information of the first number of audio signals INN obtained by the analysis unit 110.

Choosing and retrieving suitable ambient sounds from a plurality of ambient sounds stored in a database, however, is only one example. According to alternative embodiments, the ambient sound unit 112 may be further configured to generate the one or more ambient sounds related to the semantic information of the first number of audio signals INN obtained by the analysis unit 110. Suitable ambient sounds can be generated, for example, by means of a generative AI model. Suitable generative AI models are generally known and will therefore not be described in further detail herein.

As mentioned above, the sound placement unit 114 is configured to determine a placement of the one or more ambient sounds determined by the ambient sound unit 112 in one or more audio signals INN of the first number of audio signals INN, and the combiner 116 is configured to, based on the placement determined by the sound placement unit 114, combine the one or more ambient sounds determined by the ambient sound unit 112 with one or more audio signals INN of the first number of audio signals INN. The first number of audio signals INN may consist of two channels L, R of a stereo audio signal, or of five channels FL, FR, C, LS, RS of a 5.1 surround signal, to mention just a few examples. Certain ambient sounds may be combined with only some of the different channels, in order to achieve a more realistic listening experience. For example, murmurs, conversation, clapping or any other ambient sounds related to an audience typically present in a certain venue (e.g., jazz club or concert hall) may be combined only with audio signals INN of the first number of audio signals INN representing channels FL, FR, LS, RS of a 5.1 surround signal, but not to an audio signal INN representing the center channel C. Other ambient sounds related to an orchestra or band performing on a stage of a certain venue (e.g., page turning) may only be combined with an audio signal INN representing a center channel C. In this way, a highly realistic 3D listening experience may be achieved.

In addition to or instead of combining ambient sound(s) with one or more specific channels of a first number of audio signals INN, it is also possible that ambient sound(s) be added to the first number of audio signals INN such that the ambient sound(s) are perceived by a user as coming from defined positions within the listening space. Placing ambient sound(s) at specific positions around a listener can be achieved by means of Vector Base Amplitude Panning, VBAP, techniques, for example. Vector Base Amplitude Panning generally is a method for positioning virtual sources at arbitrary directions, using a setup of multiple loudspeakers. In this way, the overall 3D listening experience of a user may also be enhanced.

Ambient sounds may be added at suitable positions within an audio signal INN. For example, certain ambient sounds can typically occur at any time during, e.g., a musical piece. Murmuring, coughing, soft talking, whispering, etc. are ambient sounds that may generally occur at any time during a musical piece. Other ambient sounds such as, e.g., applause, loud talking, cheering, etc., typically occur at the end of a musical piece. The sound placement unit 114, therefore, based on the ambient sound(s) that are to be added to (combined with) the audio signals INN, may determine suitable points in time at which certain ambient sounds are to be combined with the audio signals INN. In order to determine suitable points in time at which audio signals are to be combined with the audio signals INN, the sound placement unit 114 may also take into consideration the semantic information of the first number of audio signals INN obtained by the analysis unit 110. For example, some ambient sounds may be combined with (e.g., added to) the audio signals INN when the tempo of, or the energy in the audio signals INN is slower.

Now referring to FIG. 2, an audio system 100 may further comprise a processing unit 210, wherein the processing unit 210 is configured to process the first number of audio signals INN and output a second number of processed audio signals INM*. According to some embodiments, the number of audio signals INN included in the first number of audio signals INN may equal the number of processed audio signals INM* included in the second number of processed audio signals INM*. In such cases, the processing unit 210 may be configured to, e.g., add reverberation to at least some audio signals INN included in the first number of audio signals INN. By adding reverberation to audio signals INN, different listening environments can be simulated. Systems and methods for adding reverberation to an audio signal are generally known and will therefore not be described in further detail herein.

According to further embodiments of the disclosure, the number of audio signals INN included in the first number of audio signals INN may be less than the number of processed audio signals INM* included in the second number of processed audio signals INM*. That is, the processing unit 210 may be or may comprise an upmixing processor. According to some embodiments, the first number of audio signals INN consists of two channels L, R of a stereo audio signal, and the second number of processed audio signals INM* consists of five channels FL, FR, C, LS, RS of an upmixed 5.1 surround signal. Upmixing processors and techniques are generally known and will therefore not be described in further detail herein. According to further embodiments, the processing unit 210 may be or may comprise an upmixing processor, and may additionally be configured to add reverberation to at least some audio signals INN included in the first number of audio signals INN.

According to even further examples, the audio system 100 may be configured to output the second number of audio output signals OUTM to an audio reproduction unit arranged in a listening environment. The processing unit 210 may be configured to add reverberation to at least one processed audio signal INM* of the second number of processed audio signals INM* based on a microphone signal MIC, wherein the microphone signal MIC is obtained by a microphone arranged in the listening environment.

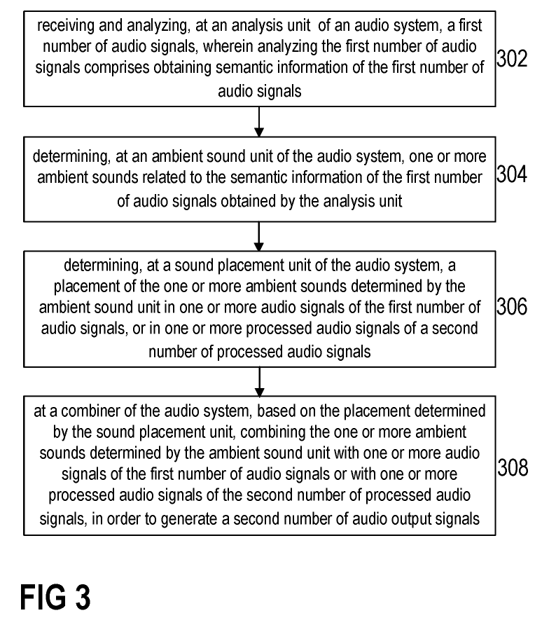

Now referring to FIG. 3, a method according to embodiments of the disclosure is schematically illustrated in a flow chart. The method comprises receiving and analyzing, at an analysis unit 110 of an audio system 100, a first number of audio signals INN, wherein analyzing the first number of audio signals INN comprises obtaining semantic information of the first number of audio signals INN (step 302). The method further comprises determining, at an ambient sound unit 112 of the audio system 100, one or more ambient sounds related to the semantic information of the first number of audio signals INN obtained by the analysis unit 110 (step 304). The method further comprises determining, at a sound placement unit 114 of the audio system 100, a placement of the one or more ambient sounds determined by the ambient sound unit 112 in one or more audio signals INN of the first number of audio signals INN, or in one or more processed audio signals INM* of a second number of processed audio signals INM* (step 306), and, at a combiner 116 of the audio system, based on the placement determined by the sound placement unit 114, combining the one or more ambient sounds determined by the ambient sound unit 112 with one or more audio signals INN of the first number of audio signals INN or with one or more processed audio signals INM* of the second number of processed audio signals INM*, in order to generate a second number of audio output signals OUTM (step 308).

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should not be understood as excluding the plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly disclose subject matter from the above description that is regarded to be novel and non-obvious.

What is claimed is:

1. An audio system comprising:
an analysis unit configured to receive and analyze a first number of audio signals by obtaining semantic information associated with the first number of audio signals;
an ambient sound unit configured to determine one or more ambient sounds related to the semantic information;
a sound placement unit configured to determine a placement of the one or more ambient sounds in one or more audio signals of the first number of audio signals or in one or more processed audio signals of a second number of processed audio signals; and
a combiner configured to combine, based on the placement determined by the sound placement unit, the one or more ambient sounds determined by the ambient sound unit with one or more audio signals in the first number of audio signals or with one or more processed audio signals in the second number of processed audio signals to generate a second number of audio output signals.

2. The audio system of claim 1, wherein obtaining semantic information associated with the first number of audio signals comprises determining at least one of: a genre, a rhythm, a melody, a structure, lyrics, a tempo, a level of noise, an energy, or a cultural background of the first number of audio signals.

3. The audio system of claim 1, wherein the ambient sound unit is further configured to generate the one or more ambient sounds related to the semantic information of the first number of audio signals.

4. The audio system of claim 3, wherein the ambient sound unit is configured to generate the one or more ambient sounds using a generative artificial intelligence model.

5. The audio system of claim 1, wherein the ambient sound unit is further configured to retrieve the one or more ambient sounds related to the semantic information of the first number of audio signals obtained by the analysis unit from a database of ambient sounds.

6. The audio system of claim 1, wherein the one or more ambient sounds comprise at least one of: murmurs, loud conversation, whispered conversation, clinking of glasses, shuffling of chairs, footsteps, foot tapping, clapping, applause, coughing, whispering, page turning sounds, near-field voices, far-field voices, cheering, chanting, whistling, rhythmic clapping, or screams.

7. The audio system of claim 1, further comprising a processing unit, wherein the processing unit is configured to process the first number of audio signals and output the second number of processed audio signals.

8. The audio system of claim 7, wherein a number of audio signals included in the first number of audio signals equals a number of processed audio signals included in the second number of processed audio signals.

9. The audio system of claim 7, wherein a number of audio signals included in the first number of audio signals is less than a number of audio signals included in the second number of processed audio signals.

10. The audio system of claim 9, wherein the first number of audio signals comprises two channels of a stereo audio signal, and wherein the second number of processed audio signals comprises five channels of an up-mixed 5.1 surround signal.

11. The audio system of claim 9, wherein the processing unit is further configured to add reverberation to at least one processed audio signal of the second number of processed audio signals.

12. The audio system of claim 11, wherein the audio system is configured to output the second number of audio output signals to an audio reproduction unit arranged in a listening environment, and wherein the processing unit is configured to add reverberation to at least one processed audio signal of the second number of processed audio signals based on a microphone signal, wherein the microphone signal is obtained by a microphone arranged in the listening environment.

13. A method comprising:
analyzing a first number of audio signals to obtain semantic information associated with a first number of audio signals;
determining one or more ambient sounds related to the semantic information;
determining a placement of the one or more ambient sounds in one or more audio signals of the first number of audio signals or in one or more processed audio signals of a second number of processed audio signals; and
combining, based on the placement, the one or more ambient sounds with one or more audio signals of the first number of audio signals or with one or more processed audio signals of the second number of processed audio signals to generate a second number of audio output signals.

14. The method of claim 13, wherein obtaining semantic information associated with the first number of audio signals comprises determining at least one of: a genre, a rhythm, a melody, a structure, lyrics, a tempo, a level of noise, an energy, or a cultural background of the first number of audio signals.

15. The method of claim 13, further comprising generating the one or more ambient sounds related to the semantic information of the first number of audio signals.

16. The method of claim 15, further comprising generating the one or more ambient sounds using a generative artificial intelligence model.

17. The method of claim 13, further comprising retrieving the one or more ambient sounds related to the semantic information of the first number of audio signals from a database of ambient sounds.

18. The method of claim 13, further comprising processing the first number of audio signals and outputting the second number of processed audio signals.

19. The method of claim 18, wherein a number of audio signals included in the first number of audio signals equals a number of processed audio signals included in the second number of processed audio signals.

20. One or more non-transitory computer-readable media storing instructions that, when executed by one or more processors, cause the one or more processors to perform a method comprising:
analyzing a first number of audio signals to obtain semantic information associated with a first number of audio signals;
determining one or more ambient sounds related to the semantic information;
determining a placement of the one or more ambient sounds in one or more audio signals of the first number of audio signals or in one or more processed audio signals of a second number of processed audio signals; and
combining, based on the placement, the one or more ambient sounds with one or more audio signals of the first number of audio signals or with one or more processed audio signals of the second number of processed audio signals to generate a second number of audio output signals.
